(19) United States
(12) Patent Application Publication
(10) Pub. No.: US 2006/0279160 A1
(43) Pub. Date: Dec. 14, 2006

(54) Rotary electric machine with a stator core made of magnetic steel sheets and the stator core thereof

(75) Inventors: Soichi Yoshinaga, Nagoya (JP); Shigenori Yoneda, Anjo-shi (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/448,806

(22) Filed: Jun. 8, 2006

(30) Foreign Application Priority Data
Jun. 8, 2005 (JP) 2005-168737
Feb. 22, 2006 (JP) 2006-045545

(51) Int. Cl. H02K 1/00; H02K 1/06; H02K 1/28; H02K 1/18

(52) U.S. Cl. 310/216; 310/218; 310/217

(57) ABSTRACT

A rotary electric machine has a housing and a stator core and a plurality of fixing members. The core has sheet units laminated along an axial direction. Each unit has core sheets disposed along a circumferential direction so as to be butted to one another on butted surfaces of the sheets. Each position of the butted surfaces of each sheet in the circumferential direction differs from any of those of other sheets adjacent to the each sheet along the axial direction. The sheets of each unit have a plurality of fixing holes disposed along the circumferential direction such that each hole in each unit is aligned with a group of holes in the other units along the axial direction. Each of the members penetrates through a group of aligned holes of the units along the axial direction and is fixed to the housing.

### CROSS-REFERENCE TO RELATED APPLICATION

This application is based upon and claims the benefit of priority of the prior Japanese Patent Application 2005-168737 filed on Jun. 8, 2005, and the prior Japanese Patent Application 2006-45545 filed on Feb. 22, 2006 so that the contents of which are incorporated herein by reference.

### BACKGROUND OF THE INVENTION

1. Field of the Invention

The present invention generally relates to a rotary electric machine wherein a stator core having magnetic steel sheets butted to one another and laminated and a coil-wound on the stator core electromagnetically interact with a rotor to convert rotational force of the rotor to electric power or to convert electric power supplied to the coil to rotational force.

2. Description of Related Art

A conventional rotary electric machine having magnetic steel core sheets combined with one another and laminated has been proposed in Published Japanese Patent First Publication No. 2001-211574. In this machine, a stator coil is wound on a cylindrical stator core to electro-magnetically induce a magnetic field, and a rotor surrounded by the stator core is rotated due to a change in the magnetic field. The stator core is composed of a plurality of circular arc-shaped partial cores placed adjacent to one another along a circumferential direction of the stator core.

More specifically, the stator core is made of a predetermined number of ring-shaped core members laminated along an axial direction of the stator core. Each core member is formed of a plurality of circular arc-shaped magnetic steel core sheets combined with-one another along the circumferential direction. Each partial core is formed of a group of core sheets of the predetermined number adjacent to one another along the axial direction. The core sheets of each core member have respective through-holes, and the core members are laminated such that each of the holes of each core member is aligned with a group of holes of the other core members along the axial direction. Each of a plurality of sheet connecting pins is struck into a group of aligned holes of the core members along the axial direction. Therefore, each group of core sheets adjacent to one another along the axial direction are fixed to one another and-unified as one partial core.

Each sheet is butted to another sheet adjacent to the each sheet along the circumferential direction on end surfaces (hereinafter, called butted surfaces) of the core sheets. When the stator core is fixed to a motor housing of the machine, it is required to determine positions of the core sheets in the circumferential and radial directions. Therefore, an outer circumferential surface of the cylindrical stator core is required to be surrounded and pressed by the housing at a preferable mechanical strength, and a fixing method such as shrinkage fitting or the like has been adopted to fix the partial cores of the stator core to the housing along plane directions perpendicular to the axial direction.

Further, magnetic resistance at an area of each butted surface inevitably becomes large. To make the resistance of the core uniform along the circumferential direction, positions of the butted surfaces in each core member are differentiated in the circumferential direction from those in other core members adjacent to each core member in the axial direction.

In this machine, although the core sheets made of the magnetic steel are expensive, these sheets can be efficiently used. Accordingly, the manufacturing cost of the machine using magnetic steel sheets can be reduced.

However, when the partial cores are fixed by the housing, a compressive stress is inevitably added to each core sheet along the plane directions. Therefore, there is high possibility that magnetic characteristics of the stator core are degraded due to distortion of the core sheets caused by the excessive compressive stress. Further, because a large-scaled motor housing surrounding each partial core is required to be heated at a high temperature in the shrinkage fitting, the manufacturing process of the machine is undesirably complicated. Moreover, because a core back portion of each core member is provided with many holes, a sectional area of a magnetic circuit in the stator core is inevitably reduced by a total area of the holes. Therefore, an amount of magnetic flux is reduced, or a density of magnetic flux is increased. As a result, rotational force obtained in the machine is undesirably reduced, or iron loss is undesirably increased.

Further, the arc-shaped core sheets forming each ring-shaped core member are required to be disposed along the circumferential direction without any open space or overlap between two core sheets butted to each other. Therefore, a position of the hole of each core sheet is determined on the basis of a distance between one end surface of the core sheet and the hole along the circumferential direction. However, accuracy in shaping end surfaces of core sheets and punching quality for holes are not so high. Therefore, when a large number of core sheets are actually manufactured, holes are inaccurately positioned in the core sheets, end surfaces of core sheets have no predetermined shape, or holes of the core sheets have no predetermined shapes. In this case, when positional relation between core sheets adjacent to each other along the circumferential direction is fixed by pins struck into holes of the core sheets, there is high probability that two core sheets butted to each other has an open space between end surfaces thereof or overlap each other along the axial direction. The open space undesirably induces the increase of a magnetic resistance of the sheet cores or the reduction of a saturated amount of magnetic flux. When the core sheets overlap each other, it is required to grind the end surfaces of the core sheets, so that a manufacturing cost of the stator core is undesirably increased.

Moreover, when each core member is shifted along the circumferential direction to differentiate positions of butted surfaces in each core member from those in other core members near (or adjacent to) the each core member, positions of holes of each core member are inevitably differentiated in the circumferential direction from those of the other core members. In this case, no connecting pin can be struck into the holes not aligned along the axial direction. To reliably align the holes of the core members along the axial direction, it is required to provide core sheets of each core member with many holes of which the number is higher than that of pins. However, in this case, each core member has holes not receiving pins, so that a manufacturing process of the machine is complicated so as to increase a manufacturing cost of the stator core.

### SUMMARY OF THE INVENTION

An object of the present invention is to provide, with due consideration to the drawbacks of the conventional machine, a rotary electric machine wherein a manufacturing process of the machine is simplified while improving magnetic characteristics of a stator core when the machine has a large number of circular arc-shaped core sheets laminated along its axial direction and butted to one another along its circumferential direction on each plane perpendicular to the axial direction.

According to a first aspect of this invention, the object is achieved by the provision of a rotary electric machine comprising a housing, a stator core, a coil wound on the stator core, a rotor being rotatable on its own axis while electromagnetically interacting with the stator core, and a plurality of fixing members fixing the stator core to the housing. The stator core has a plurality of sheet units laminated along an axial direction of the stator core. Each sheet unit has a plurality of core sheets disposed along a circumferential direction of the stator core so as to be butted to one another on butted surfaces of the core sheets. Each position of the butted surfaces of each remarked core sheet in the circumferential direction differs from positions of another core sheet which is placed away from the remarked core sheet by a predetermined number of sheet units along the axial direction. The core sheets of each sheet unit have a plurality of fixing holes disposed along the circumferential direction such that each of the fixing holes in each sheet unit is aligned with a group of fixing holes in the other sheet units along the axial direction. Each of the fixing members penetrates through a group of aligned fixing holes of the sheet units along the axial direction and is fixed to the housing.

In this arrangement, although the sheet units are laminated along the axial direction such that positions of the butted surfaces of each core sheet differs, in the circumferential direction, from those of other core sheets which are disposed to be away from the each core sheet by a predetermined number of sheet units along the axial direction, each of the fixing holes in each sheet unit is aligned with a group of fixing holes in the other sheet units along the axial direction. Therefore, each of the fixing members can easily penetrate through the aligned fixing holes of the respective sheet units along the axial direction, so that positions of the core sheets are determined by the fixing members in both the circumferential direction and a radial direction perpendicular to the circumferential and axial directions. Further, positions of the core sheets can be reliably determined by the fixing members fixed to the housing along the axial direction. Accordingly, the core sheets can be easily and reliably fixed to the housing in the stator core.

According to a second aspect of this invention based on the first aspect thereof, the object is achieved by the provision of a stator core of a rotary electric machine, comprising a plurality of sheet units laminated along an axial direction. Each sheet unit has a plurality of core sheets disposed along a circumferential direction of the sheet unit so as to be butted to one another on butted surfaces of the core sheets. Each position of the butted surfaces of each remarked core sheet in the circumferential direction differs from positions of another core sheet which is placed away from the remarked core sheet by a predetermined number of sheet units along the axial direction. The core sheets of each sheet unit have a plurality of fixing holes disposed along the circumferential direction. Each of the fixing holes in each sheet unit is aligned with a group of fixing holes of the other sheet units along the axial direction such that each of a plurality of fixing members is possible to be inserted into a group of aligned fixing holes along the axial direction.

Therefore, although positions of the butted surfaces of each core sheet in the circumferential direction differs from those of other core sheets which are disposed to be away from the each core sheet by a predetermined number of sheet units along the axial direction, each of fixing members can easily be inserted into a group of aligned fixing holes along the axial direction. Accordingly, when the fixing members are fixed to a housing of the machine, the core sheets of the stator core can be reliably and easily fixed to the housing.

### BRIEF DESCRIPTION OF THE DRAWINGS

FIG. 1 is a longitudinal sectional view of a rotary electric machine for a vehicle according to first to tenth embodiments of the present invention;

FIG. 2 is a plan view of two ring-shaped sheet units of a stator core shown in FIG. 1 according to a first embodiment;

FIG. 3 is a plan view of the stator core shown on a plane defined by axial and circumferential directions according to a modification of the first embodiment;

FIG. 4 is a plan view of three ring-shaped sheet units of a stator core shown in FIG. 1 according to a second embodiment;

FIG. 5 is a plan view of three types ring-shaped sheet units of a stator core shown in FIG. 1 according to a third embodiment;

FIG. 6 is a plan view of two ring-shaped core back sheet units of a stator core shown in FIG. 1 according to a fourth embodiment;

FIG. 7 is a plan view of a tooth sheet;

FIG. 8 is a plan view of a sheet unit assembled by fitting a plurality of tooth sheets shown in FIG. 7 to one sheet unit shown in FIG. 6;

FIG. 9 is an exploded view of both a core back portion and a tooth;

FIG. 10 is a sectional view of both a core back portion and a tooth taken substantially along a line 10-10 of FIG. 9;

FIG. 11 is a plan view of three ring-shaped core back sheet units of a stator core shown in FIG. 1 according to a fifth embodiment;

FIG. 12 is a plan view of three types ring-shaped core back sheet units of a stator core shown in FIG. 1 according to a sixth embodiment;

FIG. 13 is a plan view of three ring-shaped core back sheet units of a stator core shown in FIG. 1 according to a seventh embodiment;

FIG. 14 is a plan view of three ring-shaped core back sheet units of a stator core shown in FIG. 1 according to an eighth embodiment

FIG. 15 is a plan view of two types ring-shaped core back sheet units of a stator core shown in FIG. 1 according to a ninth embodiment;

FIG. 16 is a plan view of two types ring-shaped core back sheet units of a stator core shown in FIG. 1 according to a tenth embodiment; and

FIG. 17 is a longitudinal sectional view of a rotary electric machine for a vehicle taken according to an eleventh embodiment.

### DETAILED DESCRIPTION OF THE PREFERRED EMBODIMENTS

Embodiments of the present invention and those modifications will now be described with reference to the accompanying drawings. However, these embodiments and modifications should not be construed as limiting the present invention to those, and the structure of this invention may be combined with that based on the prior art.

### Embodiment 1

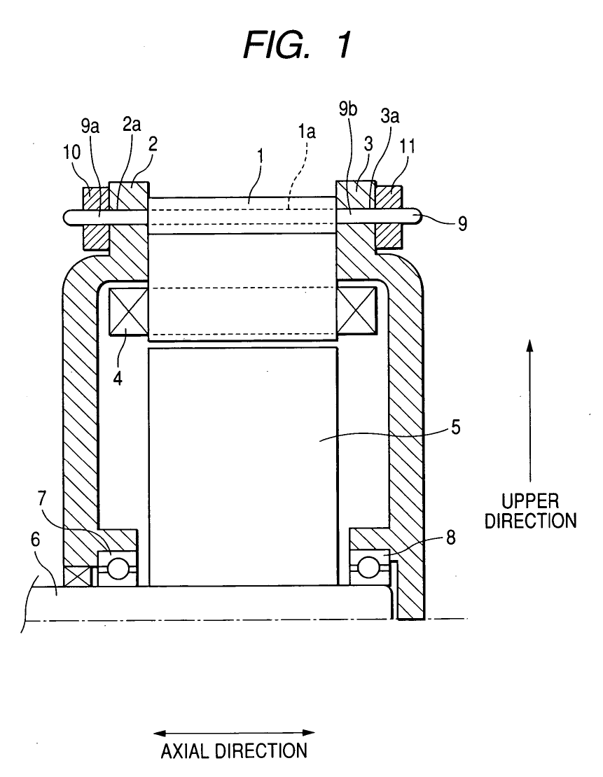

FIG. 1 is a longitudinal sectional view of a rotary electric machine for a vehicle according to first to tenth embodiments of the present invention. As shown in FIG. 1, a rotary electric machine such as an electric motor or a generator has a stator core 1 formed substantially in a cylindrical shape, a front housing 2 formed substantially in a shape of a shallow dish, a rear housing 3 formed substantially in a shape of another shallow dish, a stator coil 4 wound on the core 1 to generate a magnetic field in the core 1 in response to an alternating current or to generate an alternating current, a rotary shaft 6 being rotatable on a center axis of the core 1, and a rotor 5 disposed in a hollow space of the core 1 and being rotatable around the shaft 6 to be rotated with the shaft 6 or to rotate the shaft 6 according to an electromagnetic interaction with the core 1. The core 1 will be described in second to tenth embodiments in detail.

The machine further has bearings 7 and 8, a plurality of fixing members 9 and a pair of fastening members 10 and 11 for each member 9. The bearings 7 and 8 are fixedly disposed on inner circumferential surfaces of the housings 2 and 3 and rotatably hold the shaft 6. Each member 9 is formed in a bar shape. Each member 9 is, for example, made of a pin, a bolt such as a through bolt, a normal bolt or a stack bolt, or a screw. The member 9 may have a top portion having a larger diameter. Each fastening member is, for example, made of a nut.

The stator core 1 has eighteen teeth and eighteen slots alternately disposed along a circumferential direction thereof. The stator coil 4 has eighteen partial coils (not shown) disposed in the slots and wound on respective teeth of the core 1 according to a concentrated winding method. Six ones of the partial coils are serially connected with one another to form a phase coil corresponding to one phase. The coil 4 is composed of three phase coils connected with one another in a star connection. The winding method of the coil is not limited to a concentration type, and the coil 4 may be wounded on teeth of the core 1 according to a distributed winging method.

The stator core 1 is composed of a plurality of ring-shaped sheet units laminated along its axial direction. Each sheet unit has a predetermined number of circular arc-shaped core sheets (described later in detail) which are made of magnetic steel and are butted to one another along its circumferential direction to be formed substantially in a ring shape. The core 1 has a through-hole la extending along its axial direction every predetermined number of teeth.

The housings 2 and 3 have through-holes 2a and 3a. Each pair of holes 2a and 3a of the housings is placed at the same position as that of the corresponding through-hole 1a in the circumferential direction. Each fixing member 9 is inserted into the through-holes 2a and 3a of the housings 2 and 3 and the through-hole 1a of the stator core 1 such that both end portions 9a and 9b of the member 9 are protruded from the housings 2 and 3 in the axial direction. Each end portion has a male thread. The members 10 and 11 are screwed on respective end portions of the member 9 so as to fasten the core 1 to the housings 2 and 3 at an adequate fastening force. Therefore, the members 10 and 11 can adjustably fasten the core sheets of the stator core 1 to the housings 2 and 3 along the axial direction.

The rotor 5 is tightly fitted and fixed to the shaft 6. The rotor 5 is formed of a reluctance rotor, a permanent magnetic rotor, a field coil winding rotor or a rotor for an induction motor.

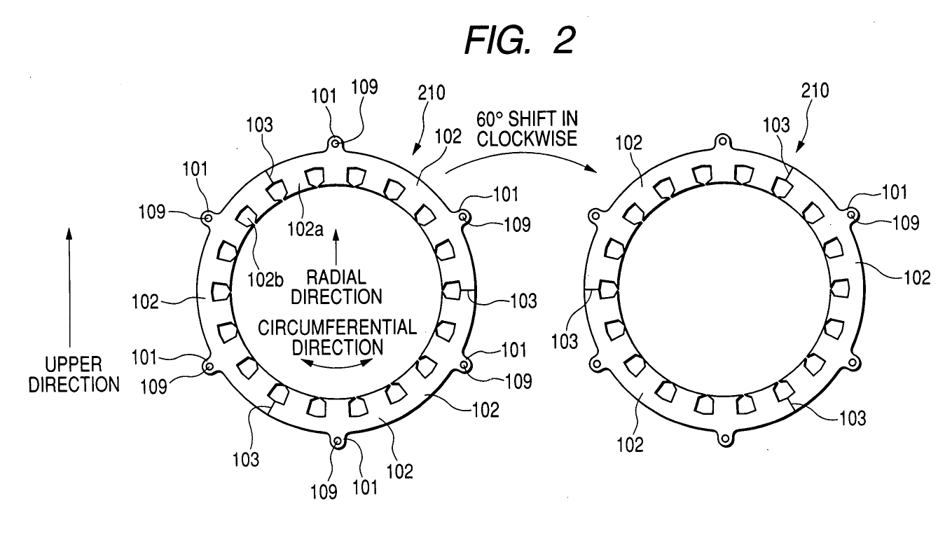

FIG. 2 is a plan view of two ring-shaped sheet units in the stator core 1 according to a first embodiment.

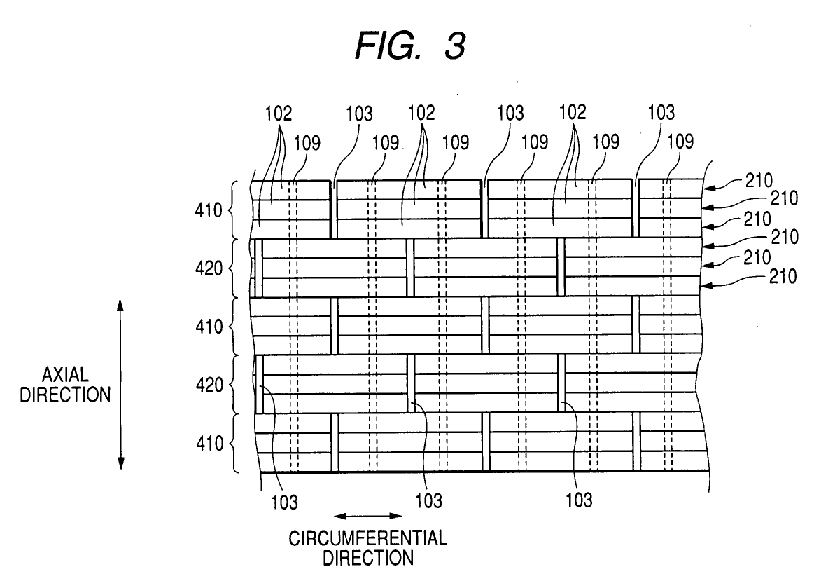

A first ring-shaped sheet unit 210 of a first orientation shown on the left side in FIG. 2 and a second ring-shaped sheet unit 210 of a second orientation shown on the left side in FIG. 2 have the same shape as each other, and a plurality of first units 210 and a plurality of second units 210 are alternately laminated along the axial direction while keeping the orientations of the units 210 shown in FIG. 3, and the core 1 is formed. The first units 210 are placed at odd-numbered positions of the core 1, and the second units 210 are placed at even-numbered positions of the core 1. Each unit 210 has three circular arc-shaped core sheets 102 which are made of magnetic steel and are disposed along the circumferential direction in a ring shape so as to be butted to or contact with one another on butted surfaces 103 of the sheets. Therefore, the three butted surfaces 103 are positioned at equal intervals of 120 degrees in the angle of circumference along the circumferential direction for each unit 210.

Each sheet 102 has a circular arc-shaped core back portion placed on its outer circumferential side and six partial teeth 102a spaced away by 20 degrees from one another through slots 102b along the circumferential direction on its inner circumferential side. Each sheet 102 further has two attaching portions 101 protruded from an outer circumferential side of the core back portion toward the outside in a radial direction perpendicular to the axial and circumferential directions. The attaching portions 101 of each unit 210 are positioned at equal intervals of 60 degrees along the circumferential direction. A core fixing through-hole 109 is formed in each attaching portion 101 so as to penetrate through the sheet 102 along the axial direction.

The unit 210 of each orientation is obtained by shifting the unit 210 of the other orientation by 60 degrees along the circumferential direction in clockwise. That is, a positional relation between the group of fixing holes 109 and the group of butted surfaces 103 along the circumferential direction in the first unit 210 is the same as that in the second unit 210, and positions of the butted surfaces of each first unit 210 are shifted or differentiated by 60 degrees from those of the respective butted surfaces of the second unit 210 which is adjacent to the each first unit 210 along the axial direction.

This shifted angle of 60 degrees in the butted surfaces 103 is equivalent to the intervals of the portions 101 along the circumferential direction. Therefore, each of the holes 109 in each unit 210 of the core 1 is inevitably placed at the same position as a group of holes 109 of the other units 210 in the circumferential and radial directions. In other words, each hole 109 in each unit 210 is aligned with a group of holes 109 of the other units 210 along the axial direction. Each group of holes 109 of the units 210 aligned along the axial direction in the core 1 forms one through-hole 1a shown in FIG. 1, and each fixing member 9 shown in FIG. 1 is inserted into one group of aligned holes 109.

The diameter of each hole 109 is set to be larger than the outer diameter of the corresponding fixing member 9 by a small value. Therefore, the fixing members 9 inserted into the holes 109 give no compressive stress on the sheets 102 along plane directions perpendicular to the axial direction. Further, a relative position of each sheet 102 with respect to the member 9 inserted into a hole 109 of the sheet 102 is adjustable due to play of the hole 109 to the member 9. Therefore, even though a distance along the circumferential direction between the center of one hole 109 and one end surface in one sheet 102 differs from a predetermined value equivalent to 30 degrees in the angle of circumference, the sheet 102 can easily be butted to an adjacent sheet 102 without any open space or overlap by shifting the sheets 102 with respect to the corresponding members 9 along the circumferential direction.

Here, each of partial cores of the core 1 is formed of a group of sheets 102 adjacent to one another along the axial direction, and the sheets 102 of the first units 210 in each group are shifted by 60 degrees from the sheets 102 of the second units 210 of the group along the circumferential direction. Therefore, in this embodiment, the core 1 has three partial cores. Every other member 9 penetrates through the holes 109 of the sheets 102 of one partial core, and each of the other members 9 alternately penetrates through the holes 109 of the sheets 102 of one partial core and the holes 109 of the sheets 102 of another partial core adjacent to the one partial core.

In this structure of the core 1, although the core 1 is assembled such that positions of the butted surfaces 103 in the circumferential direction in each unit 210 are differentiated from those in other two units 210 adjacent to the each unit 210 along the axial direction, each of the holes 109 in each unit 210 can easily be positioned to be aligned with a group of holes 109 in the other sheet units 210 along the axial direction. Therefore, each of the members 9 can easily be inserted into the corresponding group of aligned holes 109 of the units 210 along the axial direction and can reliably be fixed to the housings 2 and 3. In this case, the positions of the sheets 102 can easily be determined in the circumferential and radial directions by the member 9 inserted into the holes 109 of the sheets 102, and the positions of the sheets 102 can be determined in the axial direction by the member 9 fixed to the housings 2 and 3. Accordingly, the core 1 can reliably be fixed to the housings 2 and 3 without using the shrinkage fitting or the like, so that magnetic characteristics of the core 1 can be improved and the manufacturing process of the machine can be simplified.

Further, a maximum amount of magnetic flux in each core sheet depends on a minimum width of a magnetic path along the radial direction, and the minimum width is determined by subtracting an outer diameter of a hole from a width of the sheet along the radial direction. Because the holes 109 are disposed outside the outer circumferential surfaces of the sheets 102, the width of the magnetic path is not shortened by the holes 109. Accordingly, the density of the magnetic flux can be reduced, or the amount of the magnetic flux can be increased.

Further, because a fixing force of the member 11 to the member 9 can be adjusted, the core 1 can be fixed to the housings 2 and 3 at a sufficient mechanical strength. Moreover, because no housing is required to determine the position of the sheets 102 in the circumferential and radial directions, the housings 2 and 3 are not required to surround the outer circumferential surface of the cylindrical core 1 exposed in the radial direction. Accordingly, the housings 2 and 3 can be made in a small size and light weight. Furthermore, because the core 1 is formed of the sheets 102 having the same shape as one another, the manufacturing process of the machine can further be simplified.

Moreover, because the outer diameter of the fixing members 9 is smaller than the diameter of the holes 109, the sheets 102 can be butted to one another in each unit 210 without any open spaces or overlaps. Accordingly, magnetic resistance of the corel can be reduced, a saturated amount of magnetic flux can be heightened, and the manufacturing cost of the machine can be lowered.

Furthermore, because all the holes 109 receive the members 9, the number of holes 109 can be minimized. Accordingly, the manufacturing cost of the core 1 can be lowered.

Still further, because each sheet 102 has two holes 109, the position of the sheet 102 in the circumferential and radial directions can further reliably be determined.

When the number of sheets 102 in each unit 210 is set at a divisor of the number of slots 102b in the unit 210, each unit 210 can easily be formed of the sheets 102 having the same shape.

In this embodiment, each butted surface 103 is flat and straightly extends along the radial direction. However, the butted surface 103 may obliquely extend with respect to the radial direction or may have concave and convex portions. In this case, each pair of sheets 102 can be more closely attached to each other, so that the increase of the magnetic resistance can be further suppressed.

Further, the sheets 102 may be composed of a plurality of types of sheets having different shapes, and/or the holes 109 in each unit 210 may be disposed at different intervals along the circumferential direction.

Moreover, the first and second units 210 are alternately laminated. However, a plurality of first laminated blocks and a plurality of second laminated blocks may be alternately laminated along the axial direction. Each first block has a predetermined number N of first units 210, and the number of second blocks 210 in each second block is the predetermined number N. In this case, each of positions of butted surfaces 103 of each sheet 102 in the circumferential direction differs from any of those of other sheets 102 which are disposed to be away from the each sheet 102 by N sheets 102 along the axial direction.

FIG. 3 is a plan view of the stator core 1 shown on a plane defined by the axial and circumferential directions, according to a modification of the first embodiment.

As shown in FIG. 3, a plurality of first blocks 410 and a plurality of second blocks 420 are alternately laminated along the axial direction. Each block 410 has three first units 210 laminated along the axial direction, and each block 420 has three second units 210 laminated along the axial direction. Therefore, positions of the butted surfaces 103 of each unit 210 in the circumferential direction are the same as those of the other units 210 in each block, and each of positions of the butted surfaces 103 of each sheet 102 in the circumferential direction differs from any of those of other sheets 102 which are disposed to be away from the each sheet 102 by three sheets 102 along the axial direction.

Accordingly, the holes 109 can easily be positioned in the axial direction, and each member 9 can easily be inserted into the holes 109 of the units 210.

The number of sheets in each first block may differ from that in each second block. Further, the first blocks or the second blocks may have various numbers of sheets.

### Embodiment 2

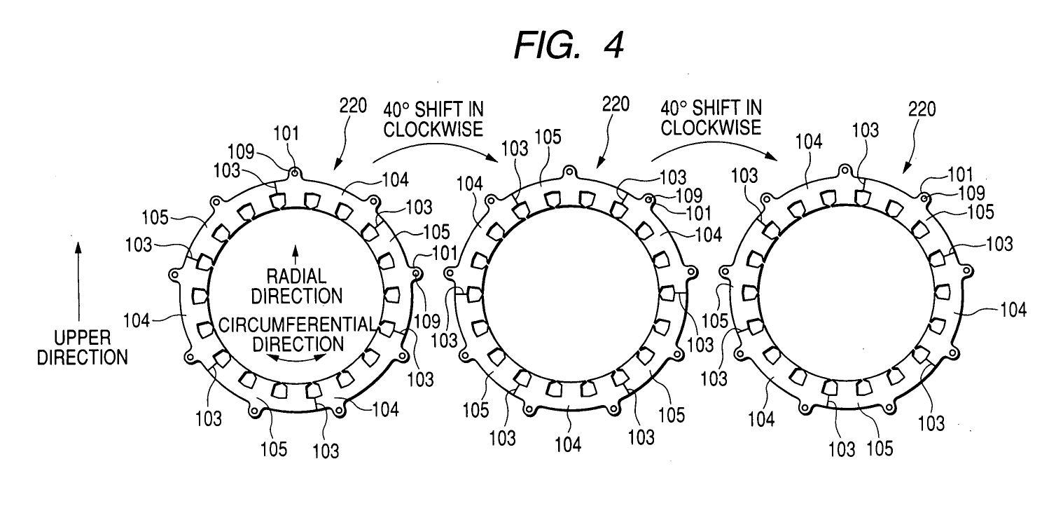

FIG. 4 is a plan view of three ring-shaped sheet units in the stator core 1 according to a second embodiment.

A first ring-shaped sheet unit 220 of a first orientation shown on the left side in FIG. 4, a second ring-shaped sheet unit 220 of a second orientation shown on the middle in FIG. 4 and a third ring-shaped sheet unit 220 of a third orientation shown on the left side in FIG. 4 have the same shape as one another. The units 220 of the three orientations are cyclically laminated along the axial direction while keeping the orientations of the units 220 shown in FIG. 3, and the core 1 is formed. That is, each unit 220 of the first orientation occupies the (3N-2)-th layer (N is a natural number), each unit 220 of the second orientation occupies the (3N-1)-th layer, and each unit 220 of the third orientation occupies the 3N-th layer.

Each unit 220 has three first circular arc-shaped core sheets 104 and three second circular arc-shaped core sheets 105 alternately disposed and butted to one another through butted surfaces 103 along its circumferential direction. Each of the sheets 104 and 105 has a circular arc-shaped core back portion placed on its outer circumferential side and three teeth along the circumferential direction. Each sheet 104 has two attaching portions 101 disposed to be away from each other by 40 degrees on its outer circumferential side. Each core sheet 105 has one attaching portion 101 disposed at the center along the circumferential direction on its outer circumferential side. The portions 101 of each unit 220 are positioned at equal intervals of 40 degrees. In the same manner as in the first embodiment, each portion 101 is protruded toward the outside along the radial direction and has one hole 109.

The unit 220 of each orientation is obtained by shifting the unit 220 of each of the other orientations by 40 degrees along the circumferential direction. That is, a positional relation between the group of fixing holes 109 and the group of butted surfaces 103 along the circumferential direction in the unit 220 of each orientation is the same as that in the unit 220 of each of the other orientations, and the butted surfaces of the unit 220 of each orientation are shifted by 40 degrees from the respective butted surfaces of the unit 220 of each of the other orientations.

This angle of 40 degrees between the butted surfaces of the units 220 of the different orientations is equivalent to the intervals of the portions 101 along the circumferential direction. Therefore, each of the holes 109 in each unit 220 is aligned with a group of holes 109 of the other units 210 along the axial direction. Each group of holes 109 of the units 210 aligned along the axial direction in the core 1 forms one through-hole la shown in FIG. 1, and each fixing member 9 shown in FIG. 1 is inserted into one group of aligned holes 109.

Therefore, in the same manner as in the first embodiment, although the units 220 are laminated such that positions of the butted surfaces 103 in the circumferential direction in each unit 220 differ from those in other two units 220 adjacent to the each unit 220 along the axial direction, the holes 109 can easily be aligned along the axial direction. Accordingly, the positions of the sheets 104 and 105 can easily be determined in the circumferential and radial directions by the members 9 inserted into the holes 109, and the positions of the sheets 104 and 105 can reliably be determined in the axial direction by the members 9 fixed to the housings 2 and 3. Therefore, the effects obtained in the first embodiment can be obtained in the same manner.

The units 220 of two orientations may be alternately laminated to form the core 1.

Further, a first block having a first predetermined number of first units 220, a second block having a second predetermined number of second units 220 and a third block having a third predetermined number of third units 220 may be cyclically laminated along the axial direction.

### Embodiment 3

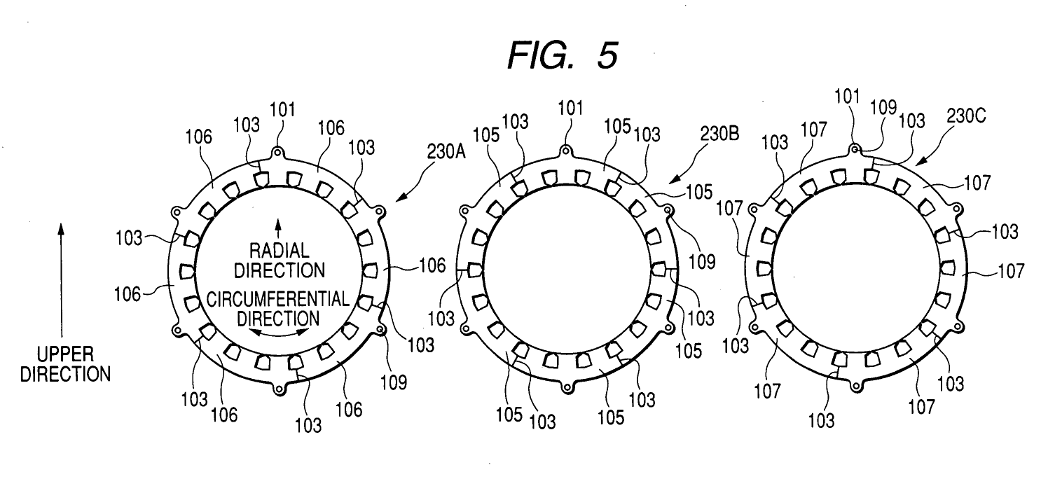

FIG. 5 is a plan view of three types ring-shaped sheet units in the stator core 1 according to a third embodiment.

A first type ring-shaped sheet unit 230A shown on the left side in FIG. 5 has six circular arc-shaped core sheets 106 made of magnetic steel. A second type ring-shaped sheet unit 230B shown on the middle in FIG. 5 has the six core sheets 105. A third type ring-shaped sheet unit 230C shown on the right side in FIG. 5 has six circular arc-shaped core sheets 107. The six sheets in each type unit are disposed along its circumferential direction to be butted to one another through butted surfaces 103. The three units 230A, 230B and 230C are cyclically laminated along the axial direction so as to align a group of holes 106 of the units along the axial direction and form the core 1.

The sheets 106 differ from the sheets 105 in that each sheet 106 has one attaching portion 101 shifted by 20 degrees in counterclockwise from that of the sheet 105. The sheets 107 differ from the sheets 105 in that each sheet 107 has one attaching portion 101 shifted by 20 degrees in clockwise from that of the sheet 105. Each sheet 107 is obtained by turning over a sheet having the same shape as that of the sheet 106, so that the unit 230C is obtained by turning over a unit having the same shape as the unit 230A. Therefore, the portions 101 in each type of unit are positioned at equal intervals of 60 degrees, and a positional relation between the group of fixing holes 109 and the group of butted surfaces 103 in each type of unit differs by 20 degrees from that in each of the other types.

When the units 230A, 230B and 230C are cyclically laminated such that each of the holes 109 in each unit 220 of the core 1 is aligned with a group of holes 109 of the other units 210 along the axial direction, the butted surfaces 103 of each type of units are shifted by 20 degrees or a pitch of one slot from the respective butted surfaces 103 of each of the other types. Each fixing member 9 shown in FIG. 1 is inserted into one group of aligned holes 109.

Therefore, in the same manner as in the first embodiment, although the units 230A to 230C are laminated such that positions of the butted surfaces 103 in the circumferential direction in each unit differ from those in another unit adjacent to the each unit, the holes 109 can easily be aligned along the axial direction. Accordingly, the positions of the sheets 105 to 107 can easily be determined in the circumferential and radial directions by the members 9 inserted into the holes 109, and the positions of the sheets 105 to 107 can reliably be determined in the axial direction by the members 9 fixed to the housings 2 and 3. Therefore, the effects obtained in the first embodiment can be obtained in the same manner.

Two of the three types of units 230A to 230C may be alternately laminated to form the core 1.

Further, a first block having a first predetermined number of first units 230A, a second block having a second predetermined number of second units 230B and a third block having a third predetermined number of third units 230C may be cyclically laminated along the axial direction.

### Embodiment 4

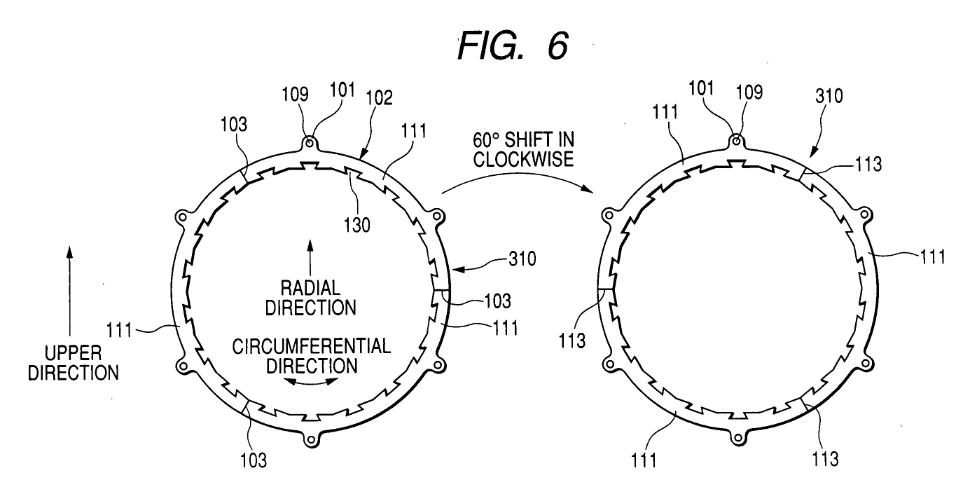

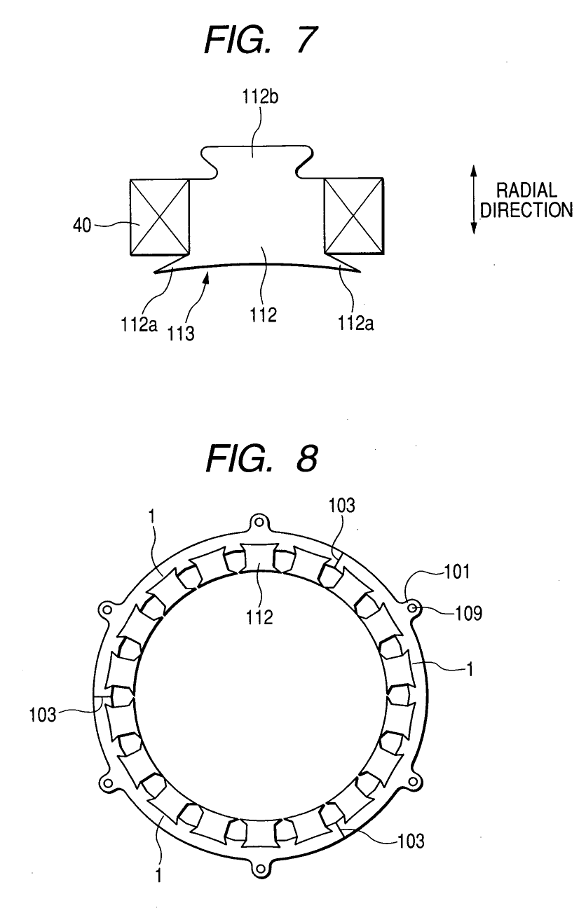

FIG. 6 is a plan view of two ring-shaped core back sheet units in the stator core 1 according to a fourth embodiment, FIG. 7 is a plan view of a tooth sheet, and FIG. 8 is a plan view of a sheet unit assembled by fitting a plurality of tooth sheets each shown in FIG. 7 to one sheet unit shown in FIG. 6.

A first ring-shaped core back sheet unit 310 of a first orientation shown on the left side in FIG. 6 and a second ring-shaped core back sheet unit 310 of a second orientation shown on the left side in FIG. 6 have the same shape as each other, and a plurality of first units 310 and a plurality of second units 310 are alternately laminated along the axial direction to form a core back of the core 1.

Each unit 310 has three circular arc-shaped core back sheets 111 which are made of magnetic steel and are disposed along the circumferential direction in a ring shape to be butted to one another on butted surfaces 103 of the sheets 111. Therefore, the butted surfaces 103 are positioned at equal intervals of 120 degrees for each unit 310.

The unit 310 of each orientation is obtained by shifting the unit 310 of the other orientation by 60 degrees along the circumferential direction. That is, the butted surfaces 103 of the first unit 310 are shifted by 60 degrees along the circumferential direction from those of the second unit 310.

Each sheet 111 has six tooth attaching grooves 130 disposed at equal intervals along the circumferential direction. Each sheet 111 further has two attaching portions 101 with holes 109 disposed to be away from each other by 60 degrees on its outer circumferential side. Therefore, the portions 101 are disposed at equal intervals of 60 degrees in each unit 310.

As shown in FIGS. 7 and 8, a tooth sheet 112 made of magnetic steel has a pair of brims 112a on its inner circumferential side and an attaching projection 112b on its outer circumferential side. The projection 112b of each sheet 112 is fitted into one of the grooves 130 of the sheets 111 so as to laminate a plurality of tooth sheets 112 along the axial direction. Each laminated set of tooth sheets 112 forms one of eighteen teeth 113 of the core 1. A partial coil 40 made of copper is wound on each tooth 113. Each sheet 112 has a substantially constant width along the circumferential direction except for the brims 112a and the projection 112b. Therefore, each partial coil 40 can be made of a coil conductor formed in a belt-like shape so as to have a large sectional area while considerably reducing open spaces formed between portions of the wound conductor.

The combination of each sheet 111 and the sheets 112 fitted to the sheet 111 is equivalent to the sheet 102 of shown in FIG. 2. The combination of the unit 310 of each orientation and the sheets 112 fitted to the unit 310 is equivalent to the unit 210 of the corresponding orientation shown in FIG. 2. Therefore, the core 1 can be made of the laminated units 310 and the sheets 112 fitted to the units 310. When the core 1 is manufactured, each partial coil 40 is wound in advance on one tooth 113 formed of a plurality of laminated tooth sheets 112, and the teeth 113 with the partial coils 40 are fitted to the units 310. The coil 40 may be wounded on one tooth by using an insulation member such as a bobbin.

Because each core sheet is made of a core back sheet and tooth sheets, a magnetic steel sheet required to obtain the core sheet can be efficiently used. Accordingly, in addition to the effects in the first embodiment, an amount of magnetic steel required to manufacture the core 1 can be reduced.

Further, the coil 40 can be wound on each tooth before the tooth sheets 112 are fitted to the units 310. Accordingly, the coil can easily wound on each tooth, and copper loss in the coil 40 can be reduced. Moreover, the coil 40 can be made of a conductor thickly formed in a belt-like shape, so that the coils 40 can be occupied in the slots at high occupation while considerably reducing open spaces in the slots. Accordingly, electric power or rotational force can efficiently be obtained.

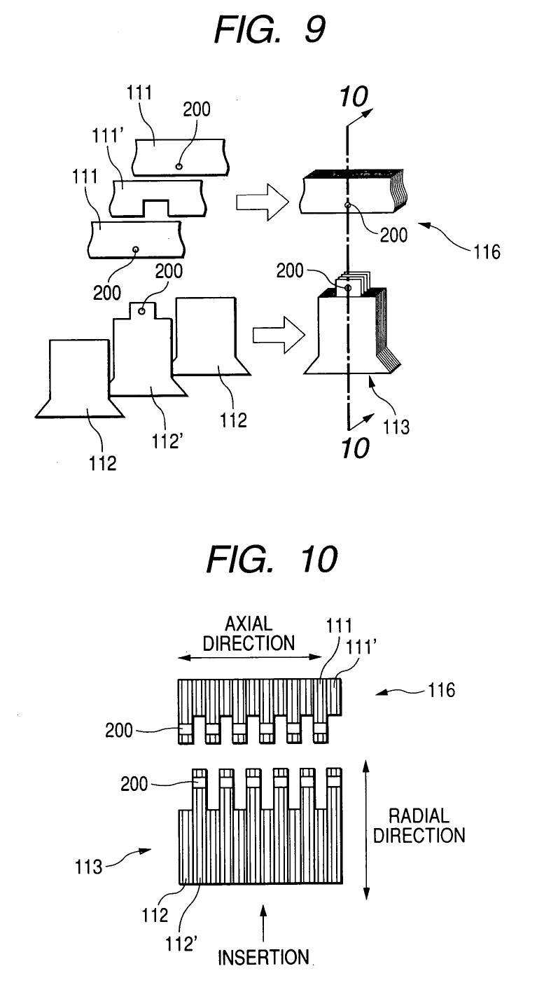

An example of combining the tooth sheets 112 with the sheets 310 is described with reference to FIGS. 9 and 10.

FIG. 9 is an exploded view of both a core back 116 and one tooth 113, and FIG. 10 is a sectional view of both a core back 116 and one tooth 113 taken substantially along a line 10-10 of FIG. 9.

As shown in FIG. 9, each tooth 113 is formed by alternately laminating a plurality of first tooth sheets 112 and second tooth sheets 112′. Each sheet 112′ has a through-hole 200. A core back 116 corresponding to one tooth 113 is formed by alternately laminating a plurality of first core back sheets 111 and second core back sheets 111′. Each sheet 111 has a through-hole 200. As shown in FIG. 10, each sheet 112 is aligned with one sheet 111, and each sheet 112′ is aligned with one sheet 111′. A connecting pin (not shown) is pushed into the holes 200 of the core back portion 116 and the tooth 113 to fix the tooth 113 to the core back 116.

Each tooth 113 may be formed by alternately laminating a plurality of blocks of sheets 112 and blocks of sheets 112′, and a core back portion 116 may be formed by alternately laminating a plurality of blocks of sheets 111 and blocks of sheets 111′. The number of sheets 112, the number of sheets 112′, the number of sheets 111 and the number of sheets 111′ in each block is the same as one another.

### Embodiment 5

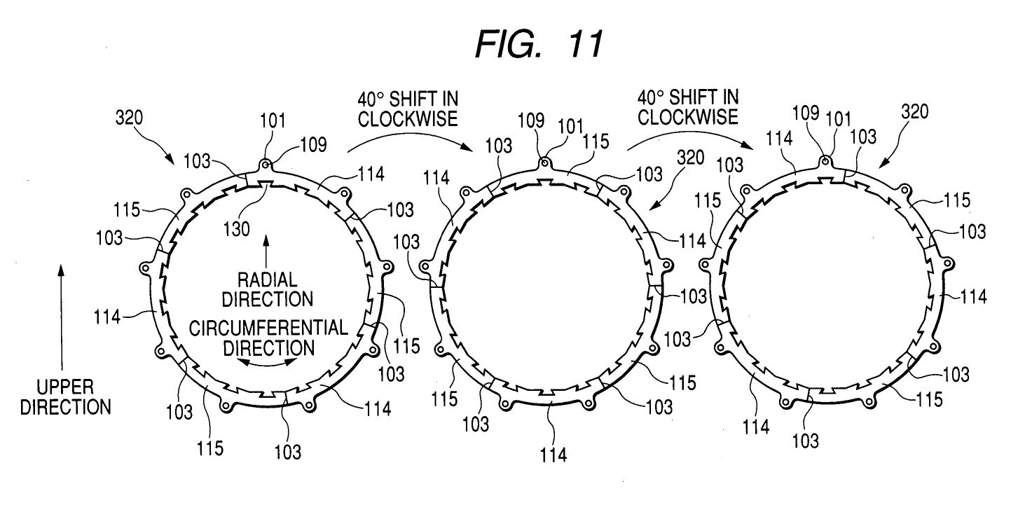

FIG. 11 is a plan view of three ring-shaped core back sheet units in the stator core 1 according to a fifth embodiment.

A ring-shaped core back sheet unit 320 of a first orientation shown on the left side in FIG. 11, a ring-shaped core back sheet unit 320 of a second orientation shown on the middle in FIG. 11 and a ring-shaped core back sheet unit 320 of a third orientation shown on the left side in FIG. 11 are cyclically laminated along the axial direction to form a core back of the core 1.

Each unit 320 has three first circular arc-shaped core back sheets 114 and three second circular arc-shaped core back sheets 115 made of magnetic steel. The sheets 114 and 115 are alternately disposed along the circumferential direction in a ring shape to be butted to one another on butted surfaces 103 of the sheets. The three butted surfaces 103 are positioned at equal intervals of 60 degrees for each unit 320.

Each sheet 114 has three tooth attaching grooves 130 and two attaching portions 101 with holes 109, and each sheet 115 has three tooth attaching grooves 130 and one attaching portion 101 with one hole 109. The tooth sheet 112 shown in FIG. 7 is fitted to each groove 130. The combination of each sheet 114 and the sheets 112 fitted to the sheet 114 is equivalent to the sheet 104 shown in FIG. 4, and the combination of each sheet 115 and the sheets 112 fitted to the sheet 115 is equivalent to the sheet 105 shown in FIG. 4.

The unit 320 of each orientation is obtained by shifting the unit 320 of each of the other orientations by 40 degrees along the circumferential direction. That is, the butted surfaces of the unit 320 of each orientation are shifted by 40 degrees from the respective butted surfaces of the unit 320 of each of the other orientations. Therefore, the combination of the unit 320 of each orientation and the sheets 112 fitted to the unit 320 is equivalent to the unit 220 of the corresponding orientation shown in FIG. 4.

Accordingly, the effects in the second and fourth embodiments can be obtained.

### Embodiment 6

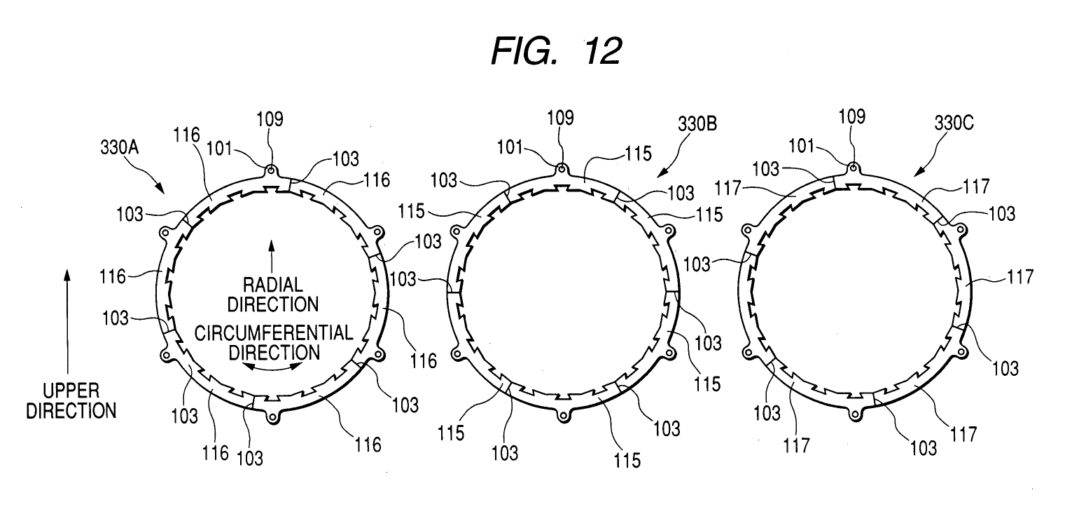

FIG. 12 is a plan view of three types ring-shaped core back sheet units in the stator core 1 according to a six embodiment.

A first type ring-shaped core back sheet unit 330A shown on the left side in FIG. 12 has six circular arc-shaped core back sheets 116 made of magnetic steel. A second type ring-shaped sheet unit 330B shown on the middle in FIG. 12 has the six sheets 115. A third type ring-shaped sheet unit 330C shown on the right side in FIG. 12 has six circular arc-shaped core back sheets 117 made of magnetic steel. The six sheets of each unit are alternately disposed in a ring shape along the circumferential direction to be butted to one another on butted surfaces 103 of the sheets. The three units 330A, 330B and 330C are cyclically laminated along the axial direction to form a core back of the core 1.

Each of the sheets 116 and 117 has three tooth attaching grooves 130 and one attaching portion 101 with one hole 109. Each sheet 117 is obtained by turning over a sheet having the same shape as one sheet 116, so that the third type unit 330C is obtained by turning over a unit having the same shape as the first type unit 330A. The tooth sheet 112 shown in FIG. 7 is fitted to each groove 130.

The combination of each sheet 116 and the sheets 112 fitted to the sheet 116 is equivalent to the sheet 107 shown in FIG. 5. The combination of each sheet 115 and the sheets 112 fitted to the sheet 115 is equivalent to the sheet 105 shown in FIG. 5. The combination of each sheet 117 and the sheets 112 fitted to the sheet 117 is equivalent to the sheet 106 shown in FIG. 5. Therefore, the combination of each unit 330A and the sheets 112 fitted to the unit 330A is equivalent to the unit 230C shown in FIG. 5, the combination of each unit 330B and the sheets 112 fitted to the unit 330B is equivalent to the unit 230B shown in FIG. 5, and the combination of each unit 330C and the sheets 112 fitted to the unit 330C is equivalent to the unit 230A shown in FIG. 5.

Accordingly, the effects in the third and fourth embodiments can be obtained.

### Embodiment 7

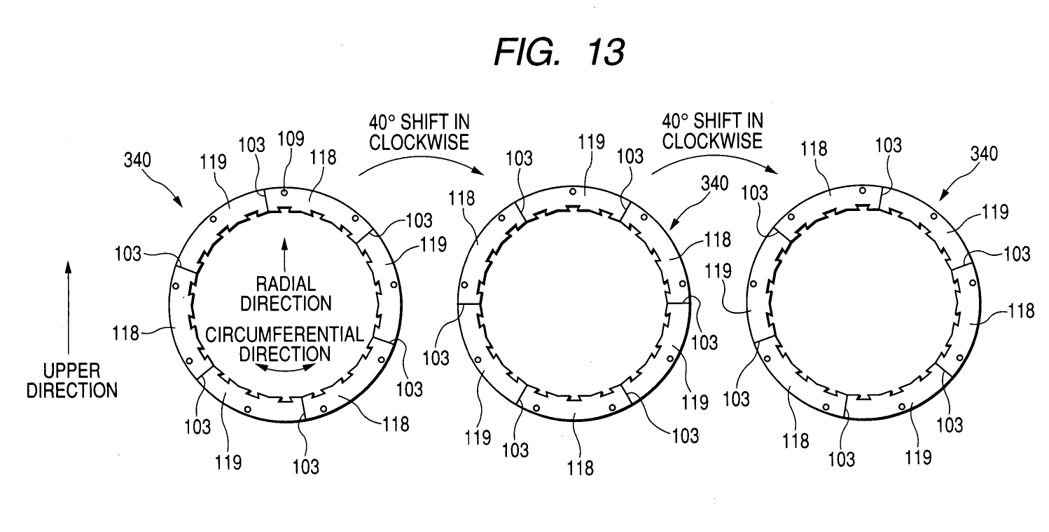

FIG. 13 is a plan view of three ring-shaped core back sheet units in the stator core 1 according to a seventh embodiment.

A ring-shaped core back sheet unit 340 of a first orientation shown on the left side in FIG. 13, a ring-shaped core back sheet unit 340 of a second orientation shown on the middle in FIG. 13 and a ring-shaped core back sheet unit 340 of a third orientation shown on the left side in FIG. 13 are cyclically laminated along the axial direction to form a core back of the core 1.

Each unit 340 has three first circular arc-shaped core back sheets 118 and three second circular arc-shaped core back sheets 119 which are made of magnetic steel and are alternately disposed along the circumferential direction in a ring shape so as to be butted to one another on butted surfaces 103 of the sheets. Therefore, the six butted surfaces 103 are positioned at equal intervals of 60 degrees in each unit 340.

Each of the sheets 118 and 119 has three tooth attaching grooves 130 in the same manner as the sheets 114 and 115 shown in FIG. 11. The tooth sheet 112 shown in FIG. 7 is fitted to each groove 130. Each sheet 118 further has two holes 109 in its outer circumferential portion at an interval of 40 degrees. Each sheet 119 further has a hole 109 at the center along the circumferential direction in its outer circumferential portion. Therefore, each sheet 340 has the nine holes 100a at equal intervals of 40 degrees, in the same manner as the unit 320 shown in FIG. 11.

Each of the sheets 118 and 119 has a width L along its radial direction, and each hole 109 of the sheets is placed within a distance of L/3 from the outer circumferential surface of the sheet along the radial direction.

The unit 340 of each orientation is obtained by shifting the unit 340 of each of the other orientations by 40 degrees along the circumferential direction. That is, the butted surfaces 103 of the units 340 of each orientation are shifted by 40 degrees from the respective butted surfaces 103 of the units 340 of each of the other orientations. Accordingly, in the same manner as the unit 320 shown in FIG. 11, each group of holes 109 of the units 340 of the core back can easily be aligned along the axial direction, and each fixing member 9 shown in FIG. 1 can easily be inserted into one group of holes 109.

Further, a length of a magnetic path in each core sheet is longest in the outer circumferential portion of the sheet as compared with those in an inner circumferential portion or a center portion of the sheet, and the holes 109 of the sheets are placed in the outer circumferential portions of the sheets. Although, the length of the magnetic path is reduced by a total length of the holes 109 in the circumferential direction, the holes 109 does not substantially shorten the length of the magnetic path. Accordingly, the increase of magnetic resistance and magnetic loss in the core 1 caused by the shortening of the magnetic path can be prevented.

Further, because no attaching portions are protruded from the outer circumferential surface of each unit 340, the cylindrical core 1 can have the smoothed outer circumferential surface. Therefore, all the outer circumferential surface of the core 1 can easily be attached to the inner circumferential surface of a cylindrical housing (not shown) of the machine. Accordingly, heat generated in the core 1 can effectively be dissipated through the housing.

### Embodiment 8

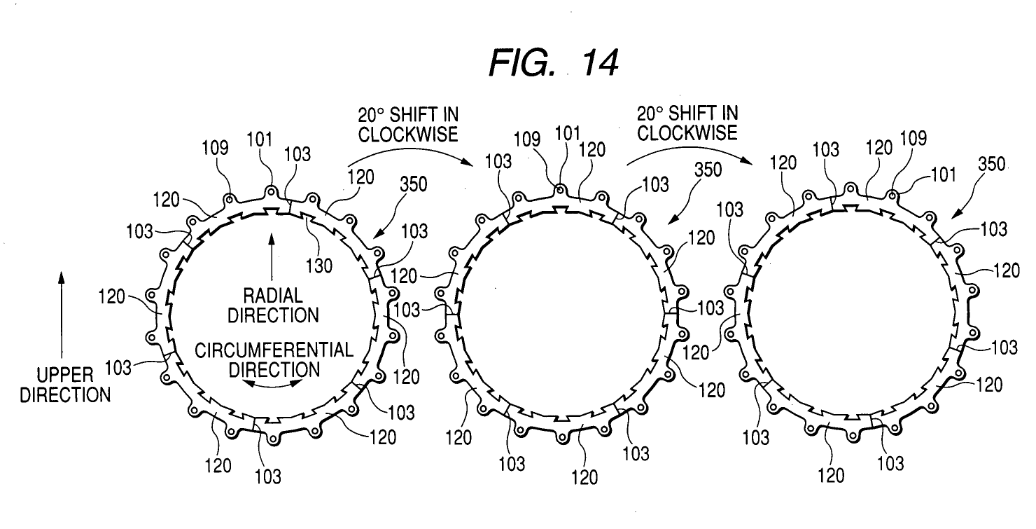

FIG. 14 is a plan view of three ring-shaped core back sheet units in the stator core 1 according to an eighth embodiment.

A ring-shaped core back sheet unit 350 of a first orientation shown on the left side in FIG. 14, a ring-shaped core back sheet unit 350 of a second orientation shown on the middle in FIG. 14 and a ring-shaped core back sheet unit 350 of a third orientation shown on the left side in FIG. 14 are cyclically laminated along the axial direction to form a core back of the core 1.

Each unit 350 has six core back sheets 120 which are made of magnetic steel and are butted to one another on butted surfaces 103 of the sheets along its circumferential direction, and six butted surfaces 103 are disposed at equal intervals of 60 degrees in each unit 350. Each sheet 120 differs from the sheets 114 and 115 shown in FIG. 11 in that the sheet 120 has three attaching portions 101 with holes 109 disposed at equal intervals of 20 degrees on its outer circumferential side. The tooth sheet 112 shown in FIG. 7 is fitted to each groove 130 of the sheets 120. The number of holes 109 in the unit 350 is twice of that in the unit 320 shown in FIG. 11.

The unit 350 of each orientation is obtained by shifting the unit 350 of each of the other orientations by 20 degrees along the circumferential direction. That is, the butted surfaces 103 of the units 350 of each orientation are shifted by 20 degrees from the respective butted surfaces 103 of the units 350 of each of the other orientations.

Accordingly, in addition to the effects obtained in the fifth embodiment, because the number of holes 109 receiving the members 9 in each unit 350 is higher than that in each unit 320, the positions of the sheets 350 can be further reliably determined in the radial and circumferential directions.

The units 350 of two orientations may be alternately laminated to form a core back of the core 1.

### Embodiment 9

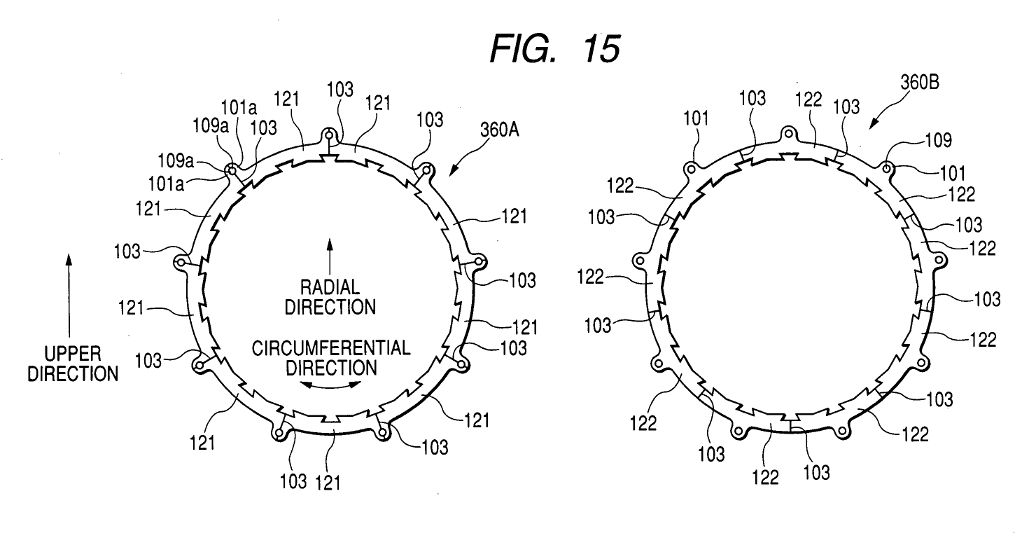

FIG. 15 is a plan view of two types ring-shaped core back sheet units in the stator core 1 according to a ninth embodiment.

A first type ring-shaped core back sheet unit 360A shown on the left side in FIG. 15 has nine circular arc-shaped magnetic core back sheets 121 made of magnetic steel. A second type ring-shaped sheet unit 330B shown on the right side in FIG. 15 has nine ring-shaped magnetic sheets 122 made of magnetic steel. The nine sheets in each unit are disposed along its circumferential direction in a ring shape to be butted to one another on butted surfaces 103 of the sheets. The units 360A and 360B are alternately laminated along the axial direction to form a core back of the core 1.

Each of the sheets 121 and 122 has two half-divided tooth attaching grooves 130a and one tooth attaching groove 130 at equal intervals along the circumferential direction. Each pair of grooves 130a between the sheets butted to each other forms one groove 130. Each sheet 121 further has a half-divided attaching portion 101a with a half-divided hole 109a at each of end sides along the circumferential direction. Each pair of portions 101a between the sheets 121 butted to each other forms one attaching portion 101 on one butted surface 103, and the holes 109a of the pair of portions 101a forms the same hole 109 as that in the first embodiment. Each sheet 122 further has one attaching portion 101 with one hole 109 at the center along the circumferential direction.

Therefore, each unit has eighteen grooves 130 at equal intervals on its inner circumferential side along the circumferential direction and has nine holes 109 at equal intervals equivalent of 40 degrees along the circumferential direction on its outer circumferential side. The tooth sheet 112 shown in FIG. 7 is fitted to each groove 130.

Positions of the butted surfaces 103 coincide with those of the holes 109 in the circumferential direction in each unit 360A, and positions of the butted surfaces 103 differ from those of the holes 109 in the circumferential direction in each unit 360. Therefore, when the units 360A and 360B are alternately laminated such that each of the holes 109 in each unit is aligned with a group of holes 109 of the other units along the axial direction, each of positions of the butted surfaces 103 of each unit in the circumferential direction differs from any of those of other sheets adjacent to the each unit along the axial direction.

Accordingly, the effects in the first embodiment can be obtained in the core 1 wherein positions of the holes 109 coincide with those of the butted surfaces 103 in the circumferential direction every two units.

In this embodiment, a groove maybe formed in each sheet 121 in place of the half-divided hole.

### Embodiment 10

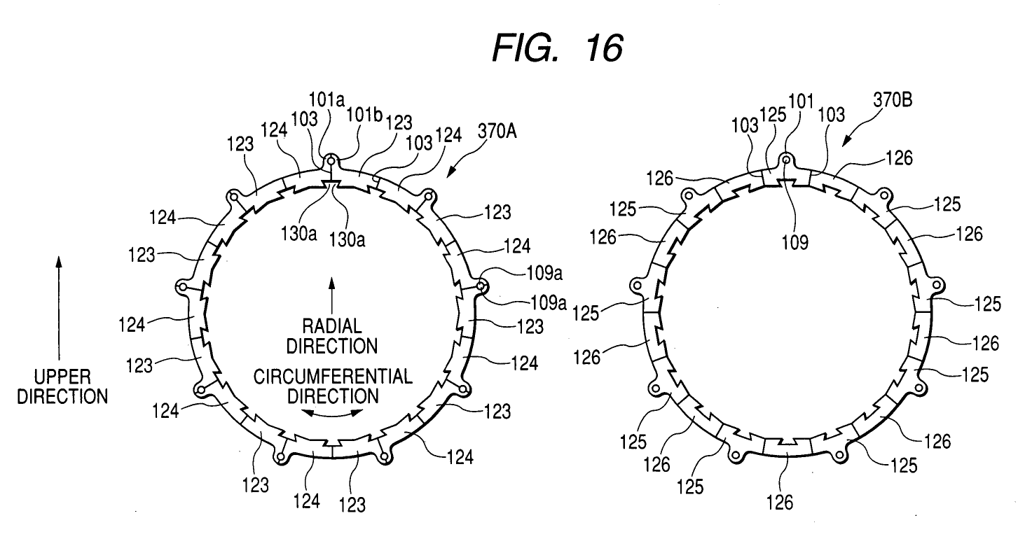

FIG. 16 is a plan view of two types ring-shaped core back sheet units in the stator core 1 according to a tenth embodiment.

A first type ring-shaped core back sheet unit 370A shown on the left side in FIG. 16 has nine circular arc-shaped magnetic core back sheets 123 and nine circular arc-shaped magnetic core back sheets 124 which are made of magnetic steel and are alternately disposed along the circumferential direction to be butted to one another on butted surfaces 103 of the sheets. A second type ring-shaped sheet unit 370B shown on the right side in FIG. 16 has nine circular arc-shaped magnetic core back sheets 125 and nine circular arc-shaped magnetic core back sheets 126 which are made of magnetic steel and are alternately disposed along the circumferential direction to be butted to one another on butted surfaces 103 of the sheets. The units 370A and 370B are alternately laminated along the axial direction to form a core back of the core 1.

Each of the sheets 123 and 124 has two half-divided tooth attaching grooves 130a disposed at its respective ends along the circumferential direction. Each pair of grooves 130a between the sheets 123 and 124 butted to each other forms one groove 130 on one butted surface 103. Each of the sheets 123 and 124 further has one half-divided attaching portion 101a with one half-divided hole 109a such that the holes 109a of the sheets 123 and 124 butted each other face each other to form one hole 109 placed in one portion 101. Each sheet 124 is obtained by turning over a sheet having the same shape as the sheet 123. Therefore, each unit 370A can be formed of a single type of sheets. Each of the sheets 125 and 126 has one tooth attaching groove 130 on its inner circumferential side. Each sheet 125 further has one attaching portion 101 with one hole 109 on its outer circumferential side.

Therefore, each unit has eighteen grooves 130 at equal intervals on its inner circumferential side along the circumferential direction and has nine holes 109 at equal intervals of 40 degrees along the circumferential direction. The tooth sheet 112 shown in FIG. 7 is fitted to each groove 130.

Each hole 109 is positioned every two butted surfaces 103 in each of the units 370A and 370B. The positions of the holes 109 coincide with those of the butted surfaces 103 in the circumferential direction in each unit 370A, and the positions of the holes 109 differ from those of the butted surfaces 103 in the circumferential direction in each unit 370B. Therefore, when the units 370A and 370B are alternately laminated such that each of the holes 109 in each unit is aligned with a group of holes 109 of the other units along the axial direction, each of positions of the butted surfaces 103 of each unit in the circumferential direction differs from any of those of other sheets adjacent to the each unit along the axial direction.

Accordingly, the effects in the first embodiment can be obtained in the core 1 wherein each hole 109 is positioned every two butted surfaces 103 in each unit and positions of the holes 109 coincide with those of the butted surfaces 103 in the circumferential direction every two units.

### Embodiment 11

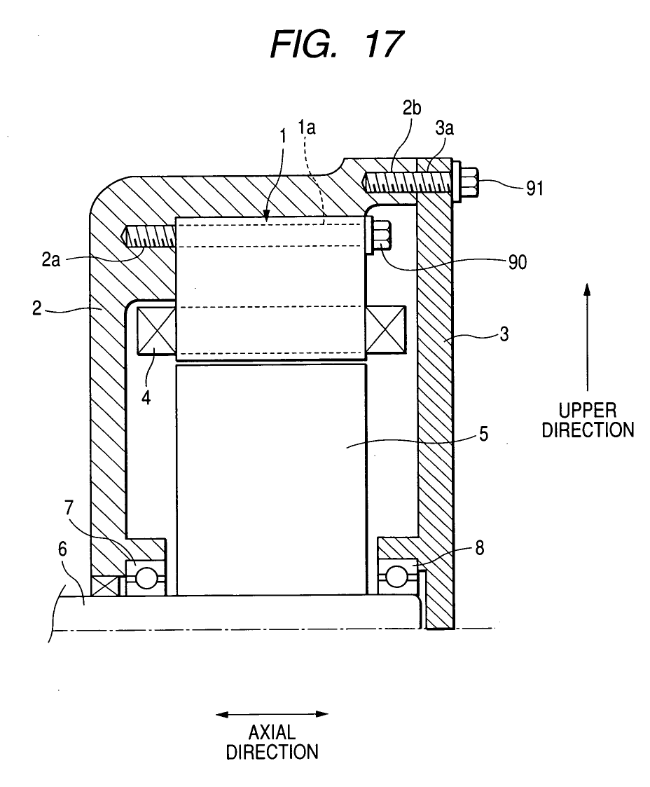

FIG. 17 is a longitudinal sectional view of a rotary electric machine for a vehicle according to an eleventh embodiment. A rotary electric machine shown in FIG. 17 differs from that shown in FIG. 1 in that a front housing 2 is formed substantially in a shape of a deep dish and has an inner surface and the core 1 is fixed to a peripheral area of the inner surface. More specifically, a fixing member 90 such as a long bolt is inserted into each hole 1a of the core 1 along the axial direction. An outer diameter of each member 90 is sufficiently smaller than the diameter of the hole 1a such that no compressive stress along plane directions perpendicular to the axial direction is added to the core 1 by the members 90. The core 1 is screwed on the housing 2 by inserting a male thread placed at a top portion of each member 90 into a female thread hole 2a of the housing 2. The housings 2 and 3 are fixed to each other by bolts 91 such that a male thread of each bolt 91 is inserted into both a hole 3a of the housing 3 and a female thread hole 2b of the housing 2. An outer circumferential surface of the core 1 may contact with a side surface of the housing 2.

Accordingly, because the core 1 is fixed to the housing 2 by the members 90 inserted into the holes 1a of the core 1 along the axial direction, the positions of the core sheets of the core 1 can be reliably determined in the axial direction.

Modification 1

Each of the tooth sheets 112 and the magnetic core back sheets according to the fourth to tenth embodiments has an axis of easy magnetization. To effectively generate magnetic field in the core 1, each sheet 112 may be disposed in the core 1 so as to have an axis of easy magnetization directed along the radial direction, and each core back sheet may be disposed in the core 1 so as to have an axis of easy magnetization directed along the circumferential direction.

Further, the core 1 may have tooth sheets 112 having an axis of easy magnetization directed along the radial direction and core back sheets made of soft magnetic steel having isotropic magnetization performance.

Modification 2

The tooth sheets 112 and the core back sheet according to each of the fourth to tenth embodiments have the same magnetic characteristics as one another or are made of the same magnetic steel as one another. However, each tooth sheet 112 may have magnetic characteristics different from those of the core back sheet, or each tooth sheet 112 may be made of magnetic steel having a composition different from that in the core back sheet.

Modification 3

Each of the core sheets according to the first to third embodiments may have insulation films on respective surfaces of the sheet, in the same manner as in a normal core sheet.

Modification 4

The core sheets or core back sheets are unified by the members 9 or 90 for each unit. However, the sheets may be unified by well-known metal unifying technique such as calking, welding or the like.

What is claimed is:

1. A rotary electric machine, comprising:
a housing;
a stator core;
a coil wound on the stator core;
a rotor which is rotatable on its own axis while electromagnetically interacting with the stator core; and
a plurality of fixing members which fix the stator core to the housing,
wherein the stator core has a plurality of sheet units laminated along an axial direction of the stator core, each sheet unit has a plurality of core sheets disposed along a circumferential direction of the stator core so as to be butted to one another on butted surfaces of the core sheets, each of positions of the butted surfaces of each core sheet in the circumferential direction differs from any of those of another core sheet which is placed away from the each core sheet by a predetermined number of sheet units along the axial direction, the core sheets of each sheet unit have a plurality of fixing holes disposed along the circumferential direction such that each of the fixing holes in each sheet unit is aligned with a group of fixing holes in the other sheet units along the axial direction, and each of the fixing members penetrates through a group of aligned fixing holes of the sheet units along the axial direction and is fixed to the housing.

2. The rotary electric machine according to claim 1, wherein the core sheets of the stator core have the same shape as one another.

3. The rotary electric machine according to claim 1, wherein each of all the core sheets of the stator core has the fixing hole.

4. The rotary electric machine according to claim 1, wherein the core sheets of each sheet unit include a plurality of specific core sheets each having at least one fixing hole and a plurality of non-hole core sheets each having no fixing hole and being disposed between two specific core sheets along the circumferential direction, and a position of the butted surface between the specific and non-hole core sheets in each pair along the circumferential direction in each sheet unit differs from any of those of the specific and non-hole core sheets in other sheet units adjacent to the each sheet unit along the axial direction.

5. The rotary electric machine according to claim 1, wherein the sheet units of the stator core are classified into a plurality of blocks adjacent to one another along the axial direction such that each block has the sheet units of the predetermined number, and the positions of the butted surfaces of the core sheets of each sheet unit along the circumferential direction are the same as those of each of the other sheet units in each block.

6. The rotary electric machine according to claim 1, wherein the core sheets in each sheet unit has a plurality of attaching portions each being protruded toward outside an outer circumferential surface of the sheet unit along a radial direction perpendicular to the circumferential and axial directions, and the fixing holes of the core sheets are placed in the respective attaching portions of the core sheets.

7. The rotary electric machine according to claim 1, wherein each core sheet has a core back portion placed on an outer circumferential side of the core sheet and a tooth portion placed on an inner circumferential side of the core sheet, and the fixing holes of the core sheets are placed in an outer circumferential portion of the core back portion placed outside both an inner circumferential portion and a center portion of the core back portion.

8. The rotary electric machine according to claim 1, wherein each core sheet has a tooth portion, on which a coil is wound, and a core back portion mechanically connected with the tooth portion.

9. The rotary electric machine according to claim 1, wherein the stator core has a plurality of slots disposed along the circumferential direction, and the number of fixing holes in the stator core is smaller than that of slots.

10. The rotary electric machine according to claim 1, wherein each core sheet has the single fixing hole.

11. The rotary electric machine according to claim 1, wherein each core sheet has two fixing holes disposed along the circumferential direction.

12. The rotary electric machine according to claim 1, wherein the core sheets include a plurality of first core sheets each having only one fixing hole and a plurality of second core sheets each having two fixing holes.

13. The rotary electric machine according to claim 1, wherein each of positions of the butted surfaces along the circumferential direction in each sheet unit differs from any of those in other sheet units adjacent to the each sheet unit along the axial direction.

14. The rotary electric machine according to claim 1, wherein a sectional area of each fixing hole on a plane perpendicular to the axial direction is set to be larger than that of the corresponding fixing member such that positions of the core sheets having the fixing holes are adjustable on a plane perpendicular to the axial direction for each sheet unit.

15. A stator core of a rotary electric machine, comprising:
a plurality of sheet units laminated along an axial direction,
each sheet unit comprising:
a plurality of core sheets disposed along a circumferential direction of the sheet unit so as to be butted to one another on butted surfaces of the core sheets,
wherein each of positions of the butted surfaces of each core sheet in the circumferential direction differs from any of those of another core sheet which is placed away from the each core sheet by a predetermined number of sheet units along the axial direction, the core sheets of each sheet unit have a plurality of fixing holes disposed along the circumferential direction, and each of the fixing holes in each sheet unit is aligned with a group of fixing holes of the other sheet units along the axial direction such that each of a plurality of fixing members is possible to be inserted into a group of aligned fixing holes along the axial direction.

16. The stator core according to claim 15, wherein a positional relation between the group of fixing holes and the group of butted surfaces along the circumferential direction in each sheet unit is the same as those in the other sheet units, the holes are positioned at equal intervals equivalent to a first angle of circumference in each sheet unit, the butted surfaces are positioned at equal intervals equivalent to a second angle of circumference in each sheet unit, and positions of the butted surfaces of each sheet unit differ by the first angle of circumference along the circumferential direction from those of the respective butted surfaces of another sheet unit which is placed away from the each sheet unit by the predetermined number of sheet units along the axial direction.

17. The stator core according to claim 16, wherein each core sheet has a plurality of fixing holes, and a positional relation between the group of fixing holes and the group of butted surfaces along the circumferential direction in each core sheet is the same as those in the other core sheets.

18. The stator core according to claim 16, wherein the core sheets in each sheet unit are classified into first core sheets and second core sheets alternately disposed along the circumferential direction, each first core sheet has only one fixing hole, and each second core sheet has two fixing holes.

19. The stator core according to claim 15, wherein the sheet units are classified into two or three types, the types of sheet units are cyclically laminated, each type has only a single type of core sheets such that a positional relation between the group of fixing holes and the group of butted surfaces in each type of sheet unit along the circumferential direction differs by a predetermined angle of circumference from that in each of the other types of sheet units, and the predetermined angle is equivalent to the positional difference between the butted surfaces of the core sheets which are away from each other by the predetermined number of sheet units along the axial direction.

20. The stator core according to claim 15, wherein the sheet units are classified into a plurality of first type sheet units and a plurality of second type sheet units, the types of sheet units are laminated such that each of the sheet units of the first type is placed away from two of the sheet units of the second type by the predetermined number of sheet units along the axial direction, the positions of the fixing holes coincide with those of the butted surfaces along the circumferential direction in each sheet unit of the first type, and the positions of the fixing holes differ from those of the butted surfaces along the circumferential direction in each sheet unit of the second type.
